(19) United States
(12) Patent Application Publication
(10) Pub. No.: US 2023/0242760 A1
(43) Pub. Date: Aug. 3, 2023

(54) COMPOSITION FOR STRIKER CAP WITH IMPROVED NOISE AND SEPARATION FORCE, STRIKER CAP, AND METHOD FOR MANUFACTURING SAME

(71) Applicants: Hyundai Motor Company, Seoul (KR); Kia Corporation, Seoul (KR); Kolon Plastics, Inc., Gimcheon (KR)

(72) Inventors: Min Gyun CHUNG, Youngin (KR); Seong Hyeon Myeong, Gimcheon (KR)

(21) Appl. No.: 18/080,561

(22) Filed: Dec. 13, 2022

(30) Foreign Application Priority Data
Jan. 11, 2022 (KR) 10-2022-0003954

(51) Int. Cl. C08L 77/06; C08K 7/14

(52) U.S. Cl. CPC C08L 77/06; C08K 7/14; C08K 2201/003; C08K 2201/004; C08L 2205/03; C08L 2205/025

(57) ABSTRACT

Disclosed are a composition for a striker cap with improved noise and separation force, a striker cap, and a method for manufacturing a striker cap. The method for manufacturing a striker cap includes: preparing a first compound by compounding a first polyamide resin and an inorganic filler; preparing a second compound by compounding a second polyamide resin and a polyolefin-based additive; blending the first compound and the second compound to obtain an admixture; and injecting the admixture.

### CROSS-REFERENCE TO RELATED APPLICATION

This application claims under 35 U.S.C. §119(a) the benefit of priority to Korean Patent Application No. 10-2022-0003954 filed on Jan. 11, 2022, the entire contents of which are incorporated herein by reference.

### TECHNICAL FIELD

The disclosure provides a composition for a striker cap with improved noise and separation force, a striker cap, and a method for manufacturing the same, and a vehicle including the striker cap. The method for manufacturing a striker cap includes steps of: preparing a first compound by compounding a first polyamide resin and an inorganic filler; preparing a second compound by compounding a second polyamide resin and a polyolefin-based additive; blending the first compound and the second compound; and injecting the admixture.

### BACKGROUND

A vehicle suspension, as a device which exists between a vehicle body and a wheel and connects these two rigid bodies using one or more links, is supported by a spring and a shock absorber in the vertical direction, and appropriately harmonizes high rigidity and flexibility in other directions, thereby performing a function of mechanically appropriately harmonizing the relative motion between the vehicle body and the wheel.

The shock absorber, as a shock absorbing device, functions to quickly absorb a road shock generated during driving and a vibration from the wheel and the vehicle body, thereby greatly improving the stability and riding comfort of a vehicle.

A striker cap located on the top of such a shock absorber can block the inflow of foreign substances into the shock absorber and to limit the behavior of the wheel through contact with a bump stopper.

In order to play these roles, the striker cap should satisfy durability. Also, when the striker cap contacts the bump stopper, the striker cap should not generate noise.

Generally, grease may be applied to the contact surface between the striker cap and bump stopper in order to reduce noise caused by friction therebetween, but its effect decreases rapidly as the mileage increases, and particularly, when a shock absorber oil is adsorbed on the surface, a noise problem increases.

Further, the striker cap may be press-fitted (forcibly inserted) into a strut rod, but in a high-temperature and high-humidity environment, a striker cap made of a conventional PA66 material is deformed by moisture absorption, which causes a field quality problem in that the striker cap is separated from the strut rod and generates ‘crack and click’ noise.

In order to solve this problem, it is necessary to improve the material that reduces the change in dimensions and physical properties even after moisture absorption.

### SUMMARY

In preferred aspects, provided are a composition for a striker cap with improved noise and separation force, a striker cap, and a method for manufacturing the same.

The object of the present disclosure is not limited to the object mentioned above. The object of the present disclosure will become clearer from the following description, and will be realized by means and combinations thereof described in the claims.

In an aspect, provided is a composition for a striker cap that includes: a first compound comprising a first polyamide resin and an inorganic filler; and a second compound comprising a second polyamide resin and a polyolefin-based additive.

The first compound may comprise: 40% by weight to 80% by weight of the first polyamide resin; and 20% by weight to 60% by weight of the inorganic filler based on the total weight of the first compound, and the second compound may comprise: 40% by weight to 80% by weight of the second polyamide resin; and 20% by weight to 60% by weight of the polyolefin-based additive based on the total weight of the second compound.

Each of the first polyamide resin and second polyamide resin may independently include one or more selected from the group consisting of polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 6I, polyamide 6/6T, polyamide 6/6I, polyamide 66/6T, polyamide 66/6I, polyamide 6/6T/6I, polyamide 66/6T/6I, polyamide 9T, polyamide 9I, polyamide 6/9T, polyamide 6/9I, polyamide 66/9T, polyamide 6/12/9T, polyamide 66/12/9T, polyamide 6/12/9I, and polyamide 66/12/6I.

The first polyamide resin and second polyamide resin suitably may be different or distinct materials. For instance, the first polyamide resin and second polyamide resin may differ in weight average molecular weight by at least 3, 5, 10, 20, 30, 40, 50, 60, 70, 80 or 100 percent or more. The first polyamide resin and second polyamide resin may differ in one or more resin repeat units. The first polyamide resin and second polyamide resin may differ in any respects, such as melt temperatures (e.g. at least about a 2, 3, 5, 10, 20, 40, 50 percent difference in melt temperatures), or differ by such amounts in one or more other physical properties.

The inorganic filler may include one or more selected from the group consisting of talc, calcium carbonate, mica, whisker, powdered glass fiber, glass fiber, spherical powder, kaolin (clay), and asbestos.

The inorganic filler may have a diameter of about 10 µm to 13 µm and a length of about 3 mm to 5 mm.

The polyolefin-based additive may include polydimethylsiloxane, ethylene-propylene-diene copolymer (EPDM), and a combination thereof.

The first compound and the second compound may have a weight ratio of about 1:0.8 to 1:1.2.

The composition for the striker cap may comprise: an amount of about 50% by weight to 80% by weight of the first polyamide resin and second polyamide resin; an amount of about 10% by weight to 20% by weight of the inorganic filler; and an amount of about 10% by weight to 30% by weight of the polyolefin-based additive based on the total composition.

In an aspect, provided is a striker cap, which may have the greater contents of the inorganic filler and polyolefin-based additive in the surface portion thereof than in the central portion thereof.

In an aspect, provided is a method for manufacturing a striker cap including steps of: preparing a first compound by compounding a first polyamide resin and an inorganic filler; preparing a second compound by compounding a second polyamide resin and a polyolefin-based additive; blending the first compound and the second compound; and injecting the admixture.

The step of preparing the first compound may include melting the first polyamide resin and inorganic filler at a temperature of about 245° C. to 265° C. and kneading the melted material at a screw rotation speed of about 200 rpm to 400 rpm.

The second compound may be prepared by melting the second polyamide resin and polyolefin-based additive at a temperature of about 245° C. to 265° C. and kneading the melted material at a screw rotation speed of about 200 rpm to 400 rpm.

The first compound and the second compound may be blended at a weight ratio of the first compound and second compound of about 1:0.8 to 1:1.2.

Further provided is a vehicle that includes the striker cap as described herein.

The composition for the striker cap according to various exemplary embodiments of the present disclosure may provide improvement in noise reduction property as well as remove the need for using grease, which makes it possible to reduce costs, and improves the separation force. Further, the composition may prevent dimensional deformation and physical property deterioration, by the manufacturing methods described herein.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 shows an exemplary method for manufacturing a striker cap according to an exemplary embodiment of the present disclosure.

FIG. 2 shows an exemplary striker cap according to an exemplary embodiment of the present disclosure.

FIG. 3 shows a reference diagram showing the RPN grade.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or combinations thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” another part, this includes not only the case where it is “directly on” the another part but also the case where there is still another part therebetween. Conversely, when a part of a layer, film, region, plate, etc. is said to be “under” another part, this includes not only the case where it is “directly under” the another part, but also the case where there is still another part therebetween.

Unless otherwise specified, all numbers, values, and/or expressions expressing quantities of components, reaction conditions, polymer compositions and formulations used in the present specification are approximate values obtained by reflecting various uncertainties of the measurement that arise in obtaining these values among others in which these numbers are essentially different. Therefore, they should be understood as being modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, when a numerical range is disclosed in this description, such a range is continuous, and includes all values from a minimum value of such a range to a maximum value including the maximum value, unless otherwise indicated. Furthermore, when such a range refers to an integer, such a range includes all integers including from a minimum value to a maximum value including the maximum value, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In an aspect, provided is a composition for a striker cap that may include: a first compound comprising a first polyamide resin and an inorganic filler; and a second compound comprising a second polyamide resin and a polyolefin-based additive.

Hereinafter, each component of the composition will be described in detail.

### First Compound

### 1) First Polyamide Resin

A polyamide resin may have excellent dispersibility as a base resin of the composition.

The first polyamide resin may include one or more selected from the group consisting of polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 6I, polyamide 6/6T, polyamide 6/61, polyamide 66/6T, polyamide 66/6I, polyamide 6/6T/6I, polyamide 66/6T/6I, polyamide 9T, polyamide 9I, polyamide 6/9T, polyamide 6/9I, polyamide 66/9T, polyamide 6/12/9T, polyamide 66/12/9T, polyamide 6/12/9I, and polyamide 66/12/61. The first polyamide resin may be preferably polyamide 6.

### 2) Inorganic Filler

The inorganic filler may prevent the separation force of a striker cap from being reduced in high temperature and high humidity conditions, and to prevent rigidity and thermal deformation of the striker cap.

The inorganic filler may include one or more selected from the group consisting of talc, calcium carbonate, mica, whisker, powder glass fiber, glass fiber, spherical powder, kaolin (clay), and asbestos.

The inorganic filler may have a diameter of about 10 µm to 13 µm and a length of about 3 mm to 5 mm.

The inorganic filler may be contained in an amount of about 10% by weight to 20% by weight based on the total composition.

When the content of the inorganic filler is less than about 10% by weight, it is impossible to prevent a decrease in the separation force after moisture absorption, and the required rigidity and thermal deformation prevention effects may be inadequate. If the content of the inorganic filler is greater than about 20% by weight, it is necessary to mix a large amount of additives to improve the noise, which may cause problems accompanying an increase in raw material price and deterioration of physical properties.

The inorganic filler may be preferably glass fiber.

The glass fiber may be in the form of chops.

The surface of the glass fiber may be treated with a coupling treatment agent.

The coupling treatment agent may include a silane-based material having an organic functional group such as a vinyl group, an epoxy group, or an amine group.

The glass fiber may reinforce mechanical properties, particularly, mechanical strength and thermal deformation temperature of the composition for the striker cap and the striker cap.

The first compound may suitably include an amount of about 60% by weight to 80% by weight of the first polyamide resin; and an amount of about 20% by weight to 40% by weight of the inorganic filler based on the total weight of the first compound.

### Second Compound

### 1) Second Polyamide Resin

The polyamide resin may excellent dispersibility as a base resin of the composition.

The second polyamide resin may include one or more selected from the group consisting of polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 6I, polyamide 6/6T, polyamide 6/61, polyamide 66/6T, polyamide 66/61, polyamide 6/6T/6I, polyamide 66/6T/6I, polyamide 9T, polyamide 91, polyamide 6/9T, polyamide 6/91, polyamide 66/9T, polyamide 6/12/9T, polyamide 66/12/9T, polyamide 6/12/91, and polyamide 66/12/6I. The second polyamide resin may be preferably polyamide 6.

### 2) Polyolefin-Based Additive

The polyolefin-based additive may improve the noise of the striker cap and improve flowability (mass production properties), mechanical rigidity, and heat resistance thereof.

The polyolefin-based additive may be one which has been master-batched.

In the case of performing blending injection after master-batching the polyolefin-based additive, the dispersion state does not become perfect unlike general injection. Therefore, the olefin component filled inside may be reduced so that the amount exposed to the actual surface increases.

The polyolefin-based additive may include polydimethylsiloxane, ethylene-propylene-diene copolymer (EPDM), or a combination thereof.

The polyolefin-based additive may be contained in an amount of about 10% by weight to 30% by weight based on the total composition.

When the polyolefin-based additive is contained in an amount of less than about 10% by weight, the noise improvement effect may be inadequate, and when it is contained in an amount is greater than about 30% by weight flowability (mass production properties) may be reduced, and mechanical rigidity and heat resistance may be reduced.

The second compound may include: an amount of about 40% by weight to 80% by weight of the second polyamide resin; and an amount of about 20% by weight to 60% by weight of the polyolefin-based additive based on the total weight of the second compound.

The first compound and second compound may have a weight ratio of about 1:0.8 to 1:1.2.

The composition for the striker cap may suitably include: an amount of about 50% by weight to 80% by weight of the first polyamide resin and second polyamide resin; an amount of about 10% by weight to 20% by weight of the inorganic filler; and an amount of about 10% by weight to 30% by weight of the polyolefin-based additive based on the total composition.

### Manufacturing Method of Striker Cap

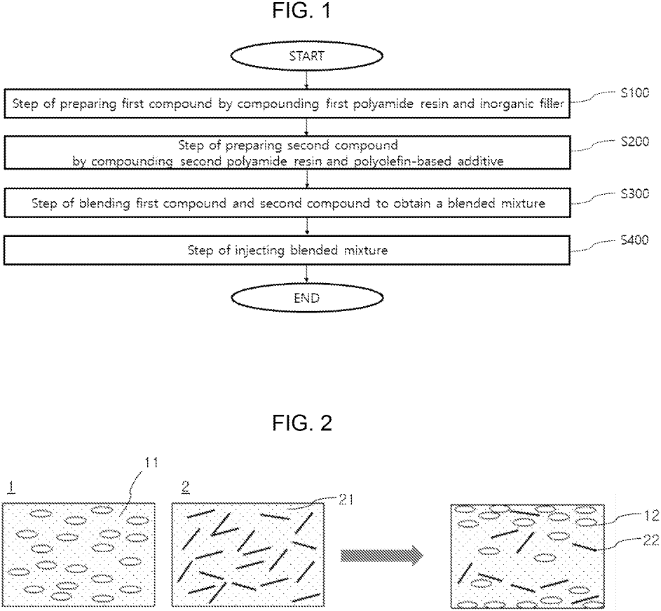

FIG. 1 shows an exemplary method for manufacturing a striker cap according to an exemplary embodiment of the present disclosure. For example, the method for manufacturing a striker cap may comprise steps of: preparing a first compound by compounding a first polyamide resin and an inorganic filler (S100); preparing a second compound by compounding a second polyamide resin and a polyolefin-based additive (S200); blending the first compound and the second compound (S300); and injecting the admixture (S400).

The step S100 may be a step of preparing the first compound.

The step of preparing the first compound may include compounding the first polyamide resin and the inorganic filler.

The step of preparing the first compound may comprise melting and kneading the first polyamide resin and inorganic filler at a temperature of about 245° C. to 265° C. using a twin-screw extruder as a mixer in order to maximize kneading of the composition.

The step of preparing the first compound may minimize the residence time in order to prevent thermal decomposition of the composition during melting and kneading, and may comprise performing kneading at a screw rotation speed of about 200 rpm to 400 rpm in consideration of dispersibility.

The step S200 may be a step of preparing the second compound.

The step of preparing the second compound may include melting and kneading the second polyamide resin and polyolefin-based additive at a temperature of about 245° C. to 265° C. using a twin-screw extruder as a mixer in order to maximize kneading of the composition.

The step of preparing the second compound may minimize the residence time in order to prevent thermal decomposition of the composition during melting and kneading, and may include performing kneading at a screw rotation speed of about 200 rpm to 400 rpm in consideration of dispersibility in the present disclosure.

The step S300 may be a step of blending the first compound and second compound.

The first compound and second compound may be blended from different compounding materials (pellets) and then injected, and the inorganic filler and polyolefin-based additive having hydrophobic properties may be further dispersed on the surface.

There has been a problem in that it is difficult to sufficiently expose the polyolefin-based additive to the surface since the amount of the polyolefin-based additive with which the inside of a material is filled during general compounding increases. Therefore, when blending injection is performed after master-batching the polyolefin-based additive, since the dispersion state does not become perfect unlike general injection, the olefin component with which the inside of the material is filled is reduced so that the amount of the polyolefin-based additive exposed to the actual surface increases.

The first compound and second compound may be blended at a weight ratio of the first compound and second compound of about 1:0.8 to 1:1.2.

The step S400 may be a step of injecting the admixture.

The injection step is not significantly different from a general injection method, and is not particularly limited.

### Striker Cap

The striker cap may be manufactured by the methods as described herein. Particularly, the surface portion thereof may have greater contents of the inorganic filler and polyolefin-based additive than the central portion thereof.

FIG. 2 shows a cross-sectional view of an exemplary striker cap according to an exemplary embodiment of the present disclosure. The striker cap may be obtained by blending a first compound 1 in which a first polyamide resin 11 and an inorganic filler 12 have been compounded and a second compound 2 in which a second polyamide resin 21 and a polyolefin-based additive 22 have been compounded, and then injecting the admixture.

### EXAMPLE

Hereinafter, the present disclosure will be described in detail with reference to the following Examples and Comparative Examples. However, the technical spirit of the present disclosure is not restricted or limited thereby.

### Experimental Example 1: Selecting Base Resin

Prior to material development, a suitable base resin was selected through a simple test in which a shock absorber oil was applied to general compounding injection specimens and a bump stopper was rubbed by hand, and then relative sizes of the rubbing sounds generated at this time were compared to one another. The results are shown in Table 1 below.

TABLE 1

| | |
|---|---|
| Material | Noise generation |
| PA66, PA6 | X |
| POM | XX |
| PA66+polydimethysiloxane | Δ |
| PA6+polydimethysiloxane | ⓄⓄ |
| PA6+ EPDM | Ⓞ |
| PA6+EPDM+GF(5% by weight) | X |

Ⓞ is good, Δ is average, and X is bad.

As shown in Table 1, polyoxymethylene (POM) as the base resin had a poor result, and even if glass fiber (GF) was put in an amount of 10% by weight or less, the result was bad. There was no difference between polyamide 66 (PA66) and polyamide 6 (PA6) as polymers, but there was a difference in the improvement effect therebetween when an olefin-based additive (polydimethylsiloxane, EPDM) was added thereto. This difference is a result shown since polyamide 6 (PA6), which has a similar melt viscosity to polyamide 66 (PA66), has more dominant dispersibility than polyamide 66 (PA66) in the compounding process, and it can be confirmed that polyamide 6 (PA6) is suitable as the base resin of the present disclosure.

### Experimental Example 2: Selecting Inorganic Filler

Prior to material development, a suitable inorganic filler was selected through a simple test. The inorganic filler was selected through evaluation of frictional force and mechanical properties. The results are shown in Table 2 below.

TABLE 2

| | | | |
|---|---|---|---|
| | Glass Fiber | MICA | Talc |
| Mechanical strength | Ⓞ | Ⓞ | Δ |
| Brittle properties (elongation, part breakage) | Ⓞ | X | Δ |
| Heat resistance | Ⓞ | Ⓞ | Ⓞ |
| Slip properties | Ⓞ | X | Δ |
| Appearance quality of injected product | Ⓞ | Δ | X |

Ⓞ is good, Δ is average, and X is bad.

As shown in Table 2, glass fiber is suitable as the inorganic filler of the present disclosure as a result of comprehensive judgment.

### Experimental Example 3: Evaluation of Noise Properties

To evaluate the quantitative noise properties, the friction noise risk (RPN (Risk Priority Number) index) was evaluated using a Ziegler friction noise tester.

$$R P N = \frac{2 ∗ R a t i n {g}_{E n e r g y r a t e} + R a t i n {g}_{I m p u l s e r a t e} + R a t i n {g}_{A c c e l e r a t i o n}}{4}$$

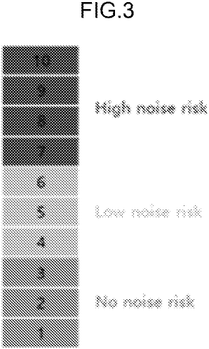

In the RPN index, the relative grades from Grades 1 to 10 are obtained by energy rate, impulse rate, and acceleration index, and Grade 1 is the most favorable for noise and Grade 10 is the most unfavorable. FIG. 3 is a reference diagram showing the RPN grade.

The results of evaluating polyamide 66 (PA66), which has been conventionally been used, at 0.2 MPa, 0.4 MPa, and 0.6 MPa which are the surface pressure conditions of a part are shown as in Table 3 below.

TABLE 3

| | Oil application | 20 N (0.2 MPa) 1 mm/s | 40 N (0.4 MPa) 1 mm/s | 60 N (0.6 MPa) 1 mm/s |
|---|---|---|---|---|
| PA66 | X | 3 | 3 | 4 |
| | 0 | 10 | 10 | 10 |

As shown in Table 3, when the shock absorber oil was applied, the RPN deteriorated from Grades 3 and 4 to Grade 10. Therefore, relative comparison was performed in the embodiment of the present disclosure by an evaluation method that appropriately simulated the part.

### Examples 1 to 3 and Comparative Examples 1 to 6

Compositions for striker cap of Examples and Comparative Examples were prepared with the compositions shown in Tables 4 and 5 below.

Striker caps of Examples and Comparative Examples were manufactured by the process method shown in Table 6 below.

TABLE 4

| Composition and process (Unit: % by weight) | | Examples | | |
|---|---|---|---|---|
| | | 1 | 2 | 3 |
| First compound | PA6 | 25-40 | 25-40 | 25-40 |
| | Glass fiber | 10 | 10 | 10 |
| Second compound | PA6 | 25-40 | 25-40 | 25-40 |
| | Polyolefin-based additive | 10 | 20 | 30 |

TABLE 5

| Composition and process (Unit: % by weight) | | Comparative Examples | | | | | |
|---|---|---|---|---|---|---|---|
| | | 1 | 2 | 3 | 4 | 5 | 6 |
| Polyamide resin | PA6 | - | 50-80 | 50-80 | 50-80 | 50-80 | 50-80 |
| | PA66 | 50-80 | - | - | - | - | - |
| Glass fiber | | - | 10 | 10 | 10 | 30 | 30 |
| Polyolefin-based additive | | - | 10 | 20 | 30 | 10 | 10 |

TABLE 6

| Composition and process (Unit: % by weight) | Examples | | | Comparative Examples | | | | | |
|---|---|---|---|---|---|---|---|---|---|
| | 1 | 2 | 3 | 1 | 2 | 3 | 4 | 5 | 6 |
| Process method | Blending injection | Blending injection | Blending injection | Injection | Injection | Injection | Injection | Injection | Blending injection |

Blending injection: After blending the first compound in which the polyamide resin and glass fiber were compounded and the second compound in which the polyamide resin and polyolefin-based additive were compounded, the admixture was injected. The process conditions are as follows.
Injection: After compounding each composition, the admixture was injected. The process conditions are as follows.

### Process Conditions

1. Extrusion
   Extruder: SM Platek Tek-30, L/D 30
   Processing temperature: (Inlet) 260 × 265 × 265 × 270 × 270 × 270 × 270 × 265 × 265 × 275° C. (Die Head)
   Injection amount: 50 kg/hr
   Screw RPM: 300
   Pelletizer RPM: 1,200
   After an extruded product was dried at 90° C. in a dehumidification dryer for 5 hours, injection or blending was performed under the above conditions, and then injection was carried out.
2. Blending
   After weighing 5 kg of each of the two types of materials so that two types of materials had a weight ratio of 1:1, the materials were injected into a tumbler with a volume of 100 mL and rotated for 5 minutes, and then 10 kg of the mixture was sampled to carry out injection under the following conditions.
3. Injection
   Injection machine: Dongshin Hydraulics 170 Tons
   Mold: ISO shrinkage rate specimen mold (60*60*2 mm)
   Processing temperature: (inlet) 265 × 270 × 270 × 275° C. (nozzle)
   Injection speed 40 to 80%, injection pressure 60 to 100%, back pressure 5 to 20 kgf/cm², and cushion amount 5 to 10 mm
   Since the respective materials had different flowability, injection was performed by adjusting speed, pressure, and the like after checking the cushion amount.
The results are as in Table 7 below.

TABLE 7

| Content (unit: % by weight) | | Examples | | | Comparative Examples | | | | | |
|---|---|---|---|---|---|---|---|---|---|---|
| | | 1 | 2 | 3 | 1 | 2 | 3 | 4 | 5 | 6 |
| Sliding speed 1 mm/s | 0.2 MPa | 3 | 2 | 2 | 10 | 6 | 6 | 5 | 7 | 4 |
| | 0.4 MPa | 3 | 2 | 1 | 10 | 7 | 6 | 6 | 8 | 6 |
| | 0.6 MPa | 3 | 1 | 1 | 10 | 7 | 7 | 5 | 8 | 6 |
| Material properties | | Satisfied | Satisfied | Satisfying the lower limit of the specification | Satisfied | Satisfied | Satisfied | Satisfying the lower limit of the specification | Satisfied | Satisfied |

Material properties – Satisfaction: Tensile strength of 60 MPa or more, heat deflection temperature of 130° C. or higher

As shown in Table 7 above, Comparative Example 1 using the conventional material polyamide 66 (PA66) has poor noise properties.

Comparative Examples 2 and 4 were prepared with the same amounts of polyamide 6 (PA6), glass fiber, and polyolefin-based additive as in Examples 1 and 3, but blending was not performed by the process method, and the noise properties of Comparative Examples 2 and 4 were inferior than those of Examples 1 and 3.

Comparative Examples 5 and 6 were prepared by putting glass fiber in an amount larger than that suggested by the present disclosure, and the test was performed by changing the process method. The noise properties of both of Comparative Example 5 and 6 were inferior to those of the Examples, and the noise properties of Comparative Example 5 in which blending was not performed is inferior than those of Comparative Example 6.

Accordingly, the composition for the striker cap according to various exemplary embodiments of the present disclosure may provide improvement in noise reduction property as well as remove the need for using grease, which makes it possible to reduce costs. Further, the composition for the striker cap according to various exemplary embodiments of the present disclosure may improve the separation force, which makes it possible to reduce dimensional deformation and physical property deterioration by the manufacturing methods described herein.

Hereinabove, embodiments of the present disclosure have been described, but those with ordinary skill in the art to which the present disclosure pertains will understand that the present disclosure may be implemented in other specific forms without changing the technical spirit or essential features thereof. Therefore, it should be understood that the embodiments described above are illustrative in all respects and not restrictive.

What is claimed is:

1. A composition for a striker cap comprising:
a first compound comprising a first polyamide resin and an inorganic filler; and
a second compound comprising a second polyamide resin and a polyolefin-based additive.

2. The composition of claim 1, wherein the first compound comprises: an amount of about 40% by weight to 80% by weight of the first polyamide resin; and an amount of about 20% by weight to 60% by weight of the inorganic filler based on the total amount of the first compound, and
the second compound comprises: an amount of about 40% by weight to 80% by weight of the second polyamide resin; and an amount of about 20% by weight to 60% by weight of the polyolefin-based additive based on the total amount of the second compound.

3. The composition of claim 1, wherein each the first polyamide resin and second polyamide resin independently comprises one or more selected from the group consisting of polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 61, polyamide 6/6T, polyamide 6/61, polyamide 66/6T, polyamide 66/6I, polyamide 6/6T/6I, polyamide 66/6T/6I, polyamide 9T, polyamide 91, polyamide 6/9T, polyamide 6/9I, polyamide 66/9T, polyamide 6/12/9T, polyamide 66/12/9T, polyamide 6/12/91, and polyamide 66/12/61.

4. The composition of claim 1, wherein the inorganic filler comprises one or more selected from the group consisting of talc, calcium carbonate, mica, whisker, powdered glass fiber, glass fiber, kaolin (clay), and asbestos.

5. The composition of claim 1, wherein a diameter of the inorganic filler ranges from about 10 µm to about 13 µm and
a length of the inorganic filler ranges from about 3 mm to about 5 mm.

6. The composition of claim 1, wherein the polyolefin-based additive comprises polydimethylsiloxane, ethylene-propylene-diene copolymer (EPDM), or combinations thereof.

7. The composition of claim 1, wherein a weight ratio of the first compound and the second compound ranges from about 1:0.8 to 1:1.2.

8. The composition of claim 1, comprising: an amount of about 50% by weight to 80% by weight of the first polyamide resin and second polyamide resin; an amount of about 10% by weight to 20% by weight of the inorganic filler; and an amount of about 10% by weight to 30% by weight of the polyolefin-based additive based on the total amount of the composition.

9. A striker cap comprising the composition of claim 1, wherein contents of the inorganic filler and the polyolefin-based additive in a surface portion is greater than that of a central portion.

10. A method for manufacturing a striker cap, the method comprising:
preparing a first compound by compounding a first polyamide resin and an inorganic filler;
preparing a second compound by compounding a second polyamide resin and a polyolefin-based additive;
blending the first compound and the second compound to obtain an admixture; and
injecting the admixture.

11. The method of claim 10, wherein the first compound comprises: an amount of about 40% by weight to 80% by weight of the first polyamide resin; and an amount of about 20% by weight to 60% by weight of the inorganic filler based on the total amount of the first compound, and
the second compound comprises: an amount of about 40% by weight to 80% by weight of the second polyamide resin; and an amount of about 20% by weight to 60% by weight of the polyolefin-based additive based on the total amount of the second compound.

12. The method of claim 10, wherein each the first polyamide resin and second polyamide resin independently comprises one or more selected from the group consisting of polyamide 6, polyamide 66, polyamide 46, polyamide 11, polyamide 12, polyamide 610, polyamide 612, polyamide 6/66, polyamide 6/612, polyamide MXD6, polyamide 6/MXD6, polyamide 66/MXD6, polyamide 6T, polyamide 61, polyamide 6/6T, polyamide 6/61, polyamide 66/6T, polyamide 66/61, polyamide 6/6T/6I, polyamide 66/6T/6I, polyamide 9T, polyamide 91, polyamide 6/9T, polyamide 6/91, polyamide 66/9T, polyamide 6/12/9T, polyamide 66/12/9T, polyamide 6/12/91, and polyamide 66/12/6I.

13. The method of claim 10, wherein the inorganic filler comprises one or more selected from the group consisting of talc, calcium carbonate, mica, whisker, powdered glass fiber, glass fiber, kaolin (clay), and asbestos.

14. The method of claim 10, wherein a diameter of the inorganic filler ranges from about 10 µm to about 13 µm and
a length of the inorganic filler ranges from about 3 mm to about 5 mm.

15. The method of claim 10, wherein the preparing the first compound comprises melting the first polyamide resin and inorganic filler at about 245° C. to about 265° C. to obtain a melted material, and kneading the melted material at a screw rotation speed of about 200 rpm to about 400 rpm.

16. The method of claim 10, wherein the polyolefin-based additive comprises polydimethylsiloxane, ethylene-propylene-diene copolymer (EPDM) or any combination thereof.

17. The method of claim 10, wherein the preparing the second compound comprises melting the second polyamide resin and polyolefin-based additive at a temperature of about 245° C. to about 265° C. to obtain a melted material, and kneading the melted material at a screw rotation speed of about 200 rpm to about 400 rpm.

18. The method of claim 10, wherein the first compound and the second compound are blended at a weight ratio of the first compound and second compound of about 1:0.8 to 1:1.2.

19. The method of claim 10, wherein the striker cap comprises: an amount of about 50% by weight to 80% by weight of the first polyamide resin and second polyamide resin; an amount of about 10% by weight to 20% by weight of the inorganic filler; and an amount of about 10% by weight to 30% by weight of the polyolefin-based additive based on the total amount of the composition.

20. A vehicle comprising a striker cap of claim 9.
